(19) United States
(12) Patent Application Publication
(10) Pub. No.: US 2025/0327251 A1
(43) Pub. Date: Oct. 23, 2025

(54) SWITCHING SYSTEM, AND CONTAINERIZED PARCEL UTILITY SYSTEM COMPRISING SAME

(71) Applicant: Robert DeDomenico, Mannington, NJ (US)

(72) Inventor: Robert DeDomenico, Mannington, NJ (US)

(21) Appl. No.: 18/861,926

(22) PCT Filed: Jan. 25, 2024
(86) PCT No.: PCT/US2024/012885

§ 371 Date: Oct. 31, 2024

Related U.S. Application Data
(60) Provisional application No. 63/481,467, filed on Jan. 25, 2023.

(51) Int. Cl. E01B 25/12; B60L 13/00

(52) U.S. Cl. CPC E01B 25/12; B60L 13/003

(57) ABSTRACT

A system comprising a track system extending along an axis of travel, the track system comprising a lower track, an upper track positioned vertically above the lower track, and opposed sidewalls that are spaced from each of the lower track and the upper track along a transverse axis. At least one vehicle is movable along the track system. Each vehicle of the at least one vehicle comprises a main body defining a payload area and at least one drive unit coupled to the main body. The at least one drive unit comprises a lower wheel configured to engage the lower track, an upper wheel configured to engage the upper track and first and second side wheel assemblies positioned on opposite sides of the body. The first and second side wheel assemblies are configured to respectively and independently engage the opposed sidewalls of the track system.

### CROSS-REFERENCE TO RELATED APPLICATION

This application claims the benefit of the filing date of U.S. Provisional Patent Application No. 63/481,467, filed Jan. 25, 2023, the entirety of which is hereby incorporated by reference herein.

### FIELD

This disclosure relates to switching systems for rail transport and rail transportation systems comprising same.

### BACKGROUND

As background on the state-of-the-art in freight, a widely used term taken as synonymous with optimized is “economy of scale,” which is a misnomer. Economy stems from ratio. Large-scale and long haul is one way to reduce the ratio of human, fuel, and manufacturing effort to transport freight. The ocean shipping industry deploys more than 500 bulk carrier ships that are too large for any of the world's major canals. These are known as “capsize” ships. Their deadweight tonnage (DWT) is in the hundreds of thousands. Their cruise speeds are around 17 miles per hour (mph). Currently they are priced out for lease at around $34,000 (USD) per day, which comes to approximately 24 ton-miles per penny. Their drawbacks include long lead times, limited ports of call (about 125 ports in 31 countries), and of course the necessity of needing such a large transport.

US land transportation includes railroads and trucks, but also pipelines and river barge traffic. The US Department of Transportation (USDOT) Bureau of Transportation Statistics (BTS) tabulates and publishes data on these modes of transportation, including revenue per ton-mile. The least expensive among them are river barges, pipelines, and railroads, at only 2 to 4 cents per ton-mile. Among these three, the railroads offer the greatest flexibility. Trucks offer even more flexibility, but at an order of magnitude or so higher cost, at around 30 cents per ton-mile, and up. There are also other forms of land transportation completely neglected in BTS statistics, though: municipal water systems (and their associated aqueducts), sewer systems, and natural gas utilities (after the “city-gate”). These are de facto freight transportation, as evidenced by the necessity of employing other freight transport modes whenever utility delivery systems are interrupted for more than relatively short periods of time.

It is a failure of oversight not to include such utility delivery systems in freight transport revenue per ton-mile statistics, because they are extremely economical and effective in the area of freight transport suffering the highest cost per ton-mile: last-mile distribution (and gathering). For example, in New York City, NY, residential water rates are such that inhabitants draw their water for about 0.5 cents per gallon, even though the weighted average distance from the reservoirs that are NYC's main source of drinking water is more than 100 miles. As each gallon of tap water is eight pounds of freight (no less than eight pounds of bottled water trucked in via the fast-moving consumer goods network), a comparison of cost per ton-mile can be made. 20 pounds, or about 2.5 gallons of tap water crossing 100 miles multiplies up to one ton-mile, and this by municipal utility is therefore less than 1.5 cents per ton-mile. As stated, USDOT BTS trucking revenue is at 30 cents per ton-mile, and that was long-haul, city-to-city, truckload freight. Last-mile delivery figures are not published by USDOT BTS but are easily calculated for any mode of distribution. Wholesale distribution routes to supermarkets and convenience stores are several dollars per ton-mile for the vehicular part of the delivery, several hundred dollars per ton-mile for the final unloading, and several thousand per ton-mile for retail store staff to shelve the product. It is no wonder that a one-dollar, half-liter bottle of water costs so many times more than if the same quantity of water had been delivered through the water utility.

These observations are made here in support of the advantages of each (and every) utility distribution (and collection) system, not just potable water. Utility (and information) systems are not trivial expenses, but they are very widely shared, and delivery value far in excess of their cost. It is desirable to provide a distribution network exchange utility system (e.g., for last-mile transportation).

### SUMMARY

Described herein, in various aspects, is a system comprising a track system extending along an axis of travel, the track system comprising a lower track, an upper track positioned vertically above the lower track, and opposed sidewalls that are spaced from each of the lower track and the upper track along a transverse axis. At least one vehicle is movable along the track system. Each vehicle of the at least one vehicle comprises a main body defining a payload area and at least one drive unit coupled to the main body. The at least one drive unit comprises a lower wheel configured to engage the lower track, an upper wheel configured to engage the upper track and first and second side wheel assemblies positioned on opposite sides of the body. The first and second side wheel assemblies are configured to respectively and independently engage the opposed sidewalls of the track system.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a top schematic view of an exemplary track system as disclosed herein.

FIG. 2 is a cross section of the schematic view of FIG. 1 taken in plane 2-2.

FIG. 3 is a cross section of the schematic view of FIG. 1 taken in plane 3-3.

FIG. 4 is a cross section of the schematic view of FIG. 1 taken in plane 4-4.

FIG. 5 is a cross section of the schematic view of FIG. 1 taken in plane 5-5.

FIG. 6 is a cross section of the schematic view of FIG. 1 taken in plane 6-6.

FIG. 7 is a cross section of the schematic view of FIG. 1 taken in plane 7-7.

FIG. 8 is a cross section of the schematic view of FIG. 1 taken in plane 8-8.

FIG. 9 is a view of a section of a track system looking along the length of the track system, showing top and bottom rail with lighting provided only for illustration.

FIG. 10 is a partial perspective view of a vehicle on the track system.

FIG. 11 is a perspective view of a portion of the track system, showing detail of a selector of the track system.

FIG. 12 is a perspective view of a portion of the track system, showing detail of a gauntlet of the track system.

FIG. 13 is a perspective view of a portion of the track system, showing detail of a spreader of the track system.

FIG. 14 is a partial perspective view of a vehicle as disclosed herein.

FIG. 15 is another partial perspective view of a vehicle as disclosed herein.

FIG. 16 is another partial perspective view of a vehicle as disclosed herein.

FIG. 17 shows a schematic top-down perspective of an exemplary drive unit.

FIG. 18 shows a partial perspective view of an exemplary embodiment of the drive unit of the vehicle, illustrating a switching assembly.

FIG. 19 is a block diagram of a computing system comprising a computing device as disclosed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a wheel” can refer to one or more of such wheels; and “a lower rail” can refer to one or more of such lower rails, and so forth.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

The word “or” as used herein means any one member of a particular list and, except where context dictates otherwise, can, in optional aspects, also include any combination of members of that list.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, if further aspects, when values are approximated by use of “approximately,” “substantially,” and “generally,” it is contemplated that values within up to 15%, up to 10%, up to 5%, or up to 1% (above or below) of the particularly stated value can be included within the scope of those aspects. In still further aspects, when angular relationships (e.g., “parallel” or “perpendicular”) are approximated by use of “approximately,” “substantially,” or “generally,” it is contemplated that angles within 15 degrees (above or below), within 10 degrees (above or below), within 5 degrees (above or below), or within 1 degree (above or below) of the stated angular relationship can be included within the scope of those aspects.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

### Transport System

The disclosed system comprises a network of track and a set of vehicles that are movable along the track. The system can further comprise one or more of the following: track connected appliances for shipping and receiving payload containers, electrical power supplies, low pressure dry air supply, installed dewatering equipment, auxiliary vertical transit tracks, and navigation, waypoint marker, and communications equipment and algorithms for system operation and user interface.

The disclosed system provides a novel interaction between the vehicles and the track. Each vehicle comprises an un-wheeled main frame fastened via vertical pin pivot to a support-navigation-drive unit at each end, such as to allow each drive unit freedom to yaw, but not pitch or roll. Each drive unit comprises six wheels. Immediately above and beneath (and in line with) the vertical pivot connection between drive unit and main frame are the upper and lower double-flanges idler wheels. The lower double-flanged metal idler wheel supports vehicle weight, maintains alignment on the track lower edge-rail, completes power supply circuit from drive motor bus to wheel to lower edge-rail, and participates in path selection at track bifurcations. The upper double-flanged metal idler wheel is spring-loaded upward to maintain alignment on the track upper edge-rail, provides power supply pick-up from upper edge-rail to wheel to drive motor bus, and participates in path selection at track bifurcations. These upper and lower double-flanged metal idler wheels ride the lower and upper track edge-rails with each flange on opposite sides of the edge-rails, so as each edge rail is nestled between the flanges, limiting freedom of movement of entire vehicle to rolling forward or reverse along (and inside of) the track. Each drive unit has also two side-frames, spring-loaded outboard, with only freedom of motion to slide inboard/outboard, and not twist or pivot with any other movement. On each side frame is mounted one pair of wheels, a drive motor, drive belt, and idler pulley to set/adjust/maintain drive belt tension. Each side frame drive motor is fitted with a drive pulley delivering power to a single drive belt that drives both side wheel axles, but each side wheel is fastened to its axle through a one-way over-run clutch, such that only the side wheel closest the direction of driven motion is driven, leaving the wheel opposite the direction of driven motion to free-wheel, as opposed to providing any driving traction. This results in a main drive configuration having lead-wheel-drive, which delivers the necessary property of not exerting driving traction via the rear wheel (relative to the driven direction) so as to prevent exerting a yaw torque moment (which would otherwise allow the upper and lower double-flanged idler wheels to be twisted misaligned so as to brake against the lower and upper track edge-rails). Each side frame is mounted to the drive unit frame so as to press the side drive wheel pair outboard against a vertical inside running surface along the wall of the enclosed track at a location approximately midway between the top and bottom of the track. The two side wheels roll on vertical axles mounted to the side frame equidistant forward and aft of the drive unit main pivot pin mount to the vehicle main frame. This results in the two pair of wheels on the two side frames making contact with the track side running surface so as to align each drive unit in parallel with the track side running surface, which is always parallel with the track upper and lower edge rails, and which keeps the upper and lower double-flanged idler wheels aligned to roll freely forward or reverse inside of and along the track. Each drive unit side frame outboard/inboard slide action is limited between an ultimate inboard (retracted) limit of position, and one of two outboard (extended) limits of position, with a bi-stable mechanical outboard limit selection mechanism such as to always have the left-side and right-side frame outboard extension position limits opposite each other. (In other words, when the left-side frame is on the short limit, the right-side frame is on the long limit, and vice-versa.) This, together with idler wheel and track geometry, results in the vehicle reacting to track bifurcation by taking either the left or the right exit.

### System Overview

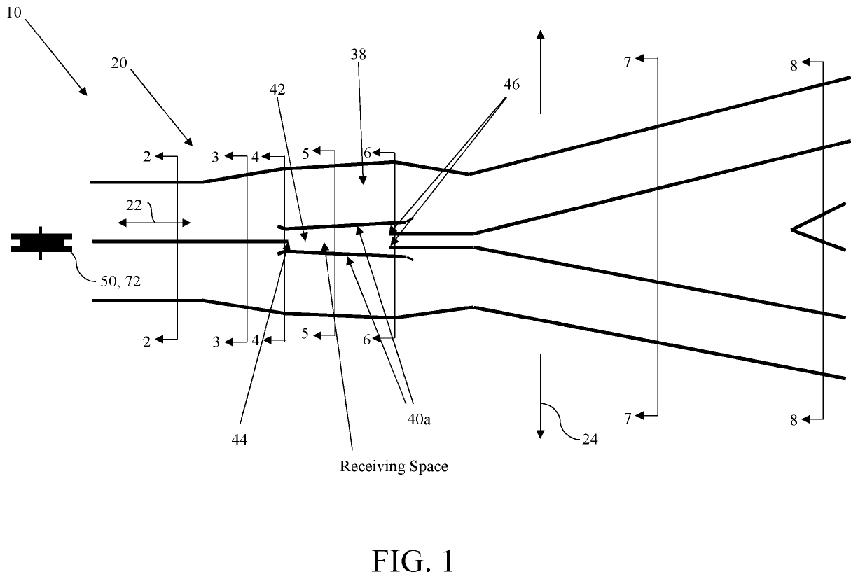

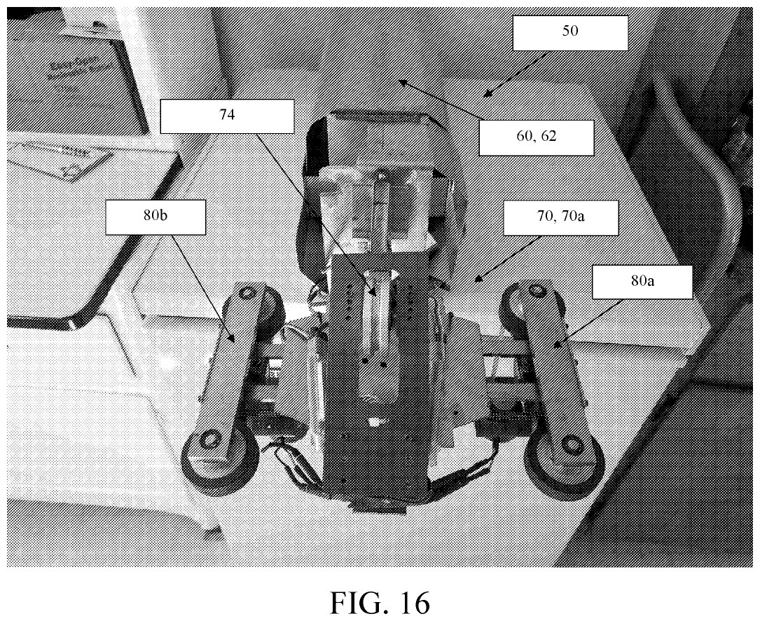

Referring to FIGS. 1, 2, and 16, a system 10 comprises a track system 20 extending along an axis of travel 22. The track system 20 can have a lower track 30 and an upper track 32 positioned vertically above the lower track. The upper track and lower track can be, for example, edge rails. The edge rails can be received within grooves of a wheel, as further disclosed herein. The track system 20 can further comprise opposed sidewalls 36 that are spaced from each other along a transverse axis 24. In some aspects, the opposed sidewalls 36 can be spaced from of the lower track and the upper track along the transverse axis 24.

The system 10 can further comprise at least one vehicle 50 that is movable along the track system 20. Each vehicle 50 of the at least one vehicle can comprise a main body 60 defining a payload area 62 and at least one drive unit 70 coupled to the main body 60. Each drive unit 70 of the at least one drive unit can comprise a lower wheel 72 configured to engage the lower track 30, an upper wheel 74 configured to engage the upper track 32, and first and second side wheel assemblies 80a,b positioned on opposite sides of the drive unit 70. The first and second side wheel assemblies 80a,b can be configured to independently and respectively engage the opposed sidewalls 36 of the track system 20.

In some aspects, each vehicle 50 can comprise a front drive unit 70a coupled to a front of the main body 60 of vehicle and a rear drive unit 70b coupled to a rear of the main body 60 of the vehicle 50. The front and rear drive units can be coupled to the body of the at least one vehicle via respective connections 76 that permit articulation about respective pivotal axes that are perpendicular to the axis of travel. In some aspects, the respective connections 76 between the front and rear drive units and the main body can permit a minimum turn radius of less than 50 inches for a main body having an overall length (kingpin to kingpin) of about 35″, with a cargo-carrying bay of about 22″ inside length.

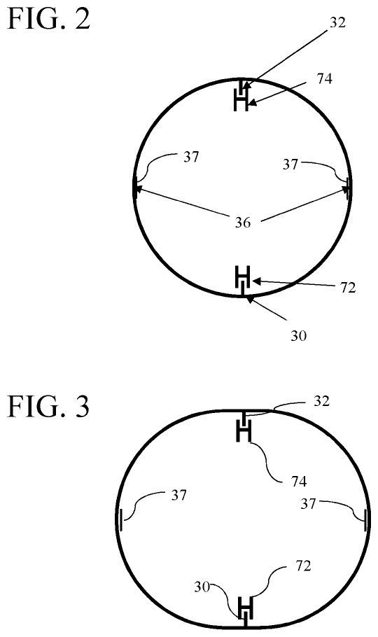

Referring to FIGS. 2-3, in some aspects, the sidewalls 36 can each comprise a respective rail 37 along at least portions of the track system 20. In some aspects, the rails 37 can comprise metal. Exemplary upper and lower rails can be roll-formed from about 1″ wide sheet (galvannealed steel, or other suitable material) of about 0.038″, or about 22 gauge sheet metal). The upper and lower rails can be held internally to the upper and lower surfaces of the track system 20 either by extruded formed keepers running longitudinally along the pipe, or by installed longitudinal keepers (e.g., PVC glued or otherwise suitably fastened so as to restrain the upper and lower edge-rails and the left and right rails 37 in place, but allow the rails to be slid longitudinally in place (for ease of system installation, as well as for potential periodic replacement). This configuration can allow ordinary PVC bell-and-spigot (gasketed or glued bell) to be easily used as the enclosing aspect of this track. In further aspects, HDPE, concrete, asphalt, or any of several other materials may also be suitable for some or all of the track.

In exemplary aspects, the track system 20 can be provided as a tubular structure, with the sidewalls 36 being rounded. In some aspects, the respective rails 37 can have generally planar surface to reduce rolling resistance and wear.

### Exemplary Bifurcation

FIG. 1 is a functional schematic diagram of a stylized overhead view of the rail and sidewall of a bifurcation 38 of a track system 20. It is contemplated that the upper and lower rails can be symmetric, or otherwise structurally similar to each other. Accordingly, in some aspects, the track in FIG. 1 can be illustrative of both the upper track and the lower track.

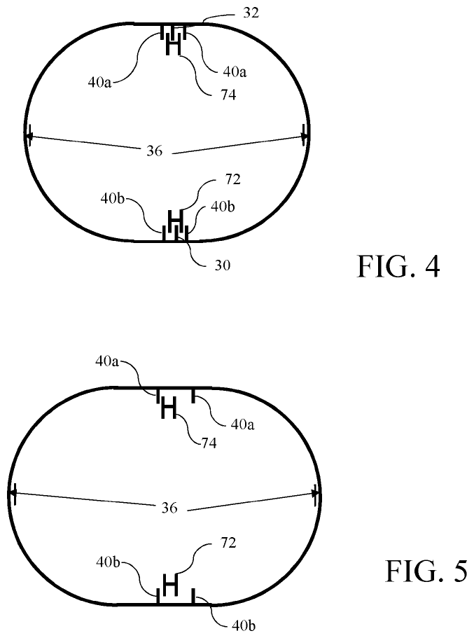

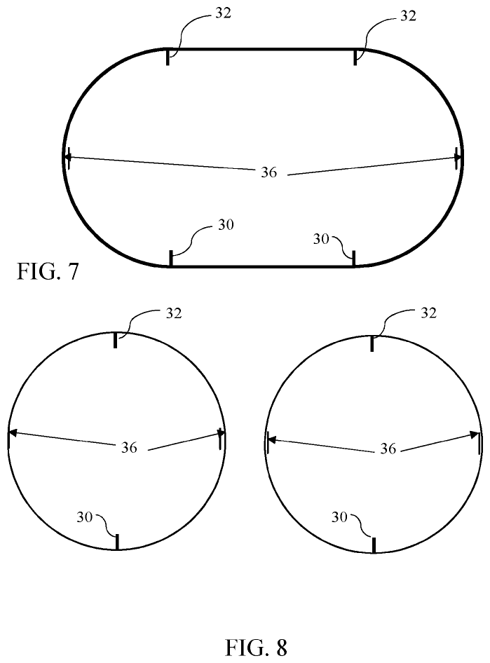

Referring to FIGS. 1-8, in exemplary aspects, the bifurcation 38 can comprise a first pair of opposed side rails 40a spaced along the transverse axis 24 and extending along the axis of travel 22 of the track system 20. The first pair of opposed side rails 40a can be positioned at a height to contact the upper wheel 74 of the at least one vehicle 50. The first pair of opposed side rails 40a can define a receiving space 42 therebetween. The upper track 32 can comprise, within the receiving space 42, a releasing end portion 44 that is configured to disengage from the upper wheel 74 when the upper wheel travels beyond the releasing end portion 44 along the axis of travel. The upper track 32 can further comprise, within the receiving space 42, a pair of receiving end portions 46 spaced from the releasing end portion 44 along the axis of travel 22. Each receiving end portion 46 of the pair of receiving end portions can be configured to receive the upper wheel when the upper wheel reaches the end portion of the pair of receiving end portions. The pair of receiving end portions 46 are positioned relative to the first pair of opposed side rails so that when the upper wheel is in contact with, and traveling along, one of the opposed side rails, the upper wheel is aligned for engagement with the respective proximate receiving end portions.

In exemplary aspects, the bifurcation 38 can comprise similar structure for engaging the lower wheel 72. For example, in some aspect, the bifurcation 38 of the track system 20 can further comprises a second pair of opposed side rails 40b spaced along the transverse axis 24 and extending along the axis of travel 22 of the track system 20. The second pair of opposed side rails 40b can be are positioned at a height to contact the lower wheel 72 of the at least one vehicle 50. The second pair of opposed side rails 40b can define a receiving space 42 therebetween. The lower track 30 can comprise, within the receiving space 42, a releasing end portion 44 that is configured to disengage from the lower wheel 72 when the lower wheel travels beyond the releasing end portion along the axis of travel. The lower track 30 can comprise, within the receiving space 42, a pair of receiving end portions 46 spaced from the releasing end portion along the axis of travel. Each receiving end portion 46 of the pair of receiving end portions can be configured to receive the lower wheel 72 when the lower wheel reaches the end portion of the pair of receiving end portions. The pair of receiving end portions 46 can be positioned relative to the second pair of opposed side rails 40b so that when the lower wheel 72 is in contact with, and traveling along, one of the opposed side rails, the lower wheel is aligned for engagement with the respective proximate receiving end portions 46.

Each vehicle 50 can be configured to engage the track system 20 so that, based on the configuration of the vehicle, the vehicle engages either one or the other of the receiving end portions 46 to determine which direction the vehicle travels at the bifurcation. In particular, the contact between one of the side wheel assemblies 80 and the respective sidewall 36 can cause the vehicle 50 to engage the receiving end portion 46 opposite the side wheel assemblies 80 biasing against the respective sidewall 36.

In exemplary aspects, the track system 20 can comprise a convergence. In some aspects, a convergence can be identical to a bifurcation, with the vehicle traveling in the opposite direction.

### Exemplary Vehicle

In some aspects, the first and side wheel assemblies 80a,b of each drive unit 70 can be biased outwardly from the main body along the transverse axis 24.

The vehicle 50 can comprise at least one switch 90 that is configured to selectively limit outward travel of one of the first and second side wheel assemblies relative to the main body along the transverse axis 24. In some optional aspects, the at least one switch can comprise a pawl (not shown) and a ratchet 94. The pawl can be configured to engage the ratchet to inhibit outward travel of one of the first and second side wheel assemblies relative to the main body along the transverse axis. For example, the first and second side wheel assemblies can be spring-biased outwardly, and the switch 90 can inhibit the spring bias from causing the limited side wheel assembly from contacting the sidewall.

In exemplary aspects, the upper wheel 74 and the lower wheel 72 can be each spring-biased away from the main body of the at least one vehicle.

In some aspects, each drive unit 70 of the vehicle 50 can comprise at least one motor. The first and second side wheel assemblies 80a,b can each comprise at least one drive wheel that is operatively coupled to the at least one electric motor. In further aspects, the vehicle can comprise a battery in communication with the at least one motor.

In some aspects, the upper track 32 and the lower track 20 can define a voltage differential therebetween. In these aspects, the vehicle 50 can be configured to draw power from the voltage differential between the upper track and the lower track. In some aspects, the vehicle can comprise circuitry comprising a capacitor; and at least one diode. The circuitry can be configured to auctioneer power in order to prioritize power usage from the voltage differential between the upper track and the lower track.

In some aspects, each of the first and second side wheel assemblies can comprise a front wheel 82 and a rear wheel 84.

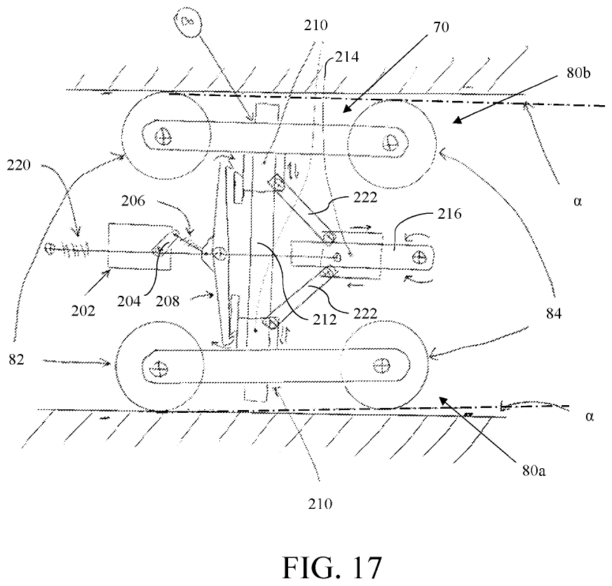

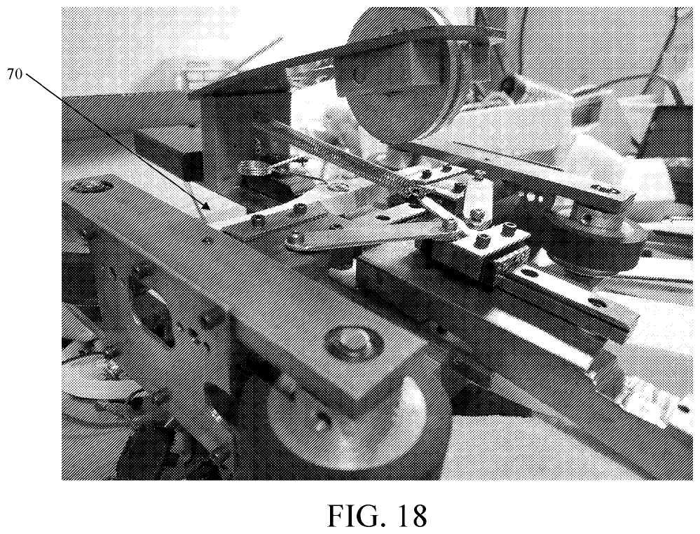

In some aspects, each drive unit 70 can comprise a frame that supports the first and second side wheel assemblies 80a,b. Referring to FIG. 17, each side frame of each drive unit can hold the lead wheel 82 slightly outboard of the trailing wheel 84. This configuration can improve performance (e.g., reduce likelihood of error) at bifurcations. It is contemplated that this configuration can result in canting the drive unit slightly toward the direction that the differential side push causing the vehicle to travel. This results satisfactory performance in path selection at bifurcation, without requiring excessive side force that could otherwise incur untenable disadvantages. This configuration provides further advantages, including application of more normal force on the driven wheel than on the undriven wheel (for each side frame), which reduces rolling resistance and energy. In some aspects, the vehicle can be configured to selectively be positioned in one of two states, depending on the direction of the vehicle: one in which the front wheel 82 of each side wheel assembly of each drive unit is held outwardly relative to the rear wheel 84 of each side unit of each drive unit, and one in which the rear wheel of each side wheel assembly is held outwardly (for when the vehicle is traveling with the rear drive unit 70b on the leading end). In some aspects, this selectable configuration can be provided by a king-pin mount and servo (onboard each side frame) or other actuated repositioner that receives an advance directional cue from the main (bi-directional) throttle signal, and throttle signal to electronic speed controller interlocked to await correct positioning of the front and rear drive units 70a,b before advancing drive signal to motor.

FIG. 17 further illustrates a slight angle a subtended by the mount of each side wheel frame to its respective linear bearing slide block. The angle is slightly off orthogonal so as to result in a slight toe-out configuration. This results in greater normal force of the lead wheel 82 on the side wall. Additionally, this configuration imparts a slight angle in the direction of the intended path at every track bifurcation. This happens because the side wheels on the side frame on its short limit are restrained from maintaining contact with their track side rail, leaving in contact only the side wheels on the long limit side frame which is pushing off its track side rail. In this manner, this onboard switch both steers and pushed the drive unit so as to trap onto the desired one (of two) exit rails at the selection portion of a track bifurcation.

### Computing System

The system 10 can comprise a computing device in communication with each vehicle of the at least one vehicle. The computing device can comprise at least one processor; and a memory in communication with the at least one processor, wherein the memory comprises instructions that, when executed by the at least one processor, cause the at least one processor to control movement of each vehicle of the at least one vehicle.

The system of claim 16, wherein the track system comprises at least one track convergence, wherein the memory comprises instructions that, when executed by the at least one processor, cause the at least one processor to control movement of each vehicle of the at least one vehicle to prevent collisions at the convergence. In some aspects, the memory comprises instructions that, when executed by the at least one processor, cause the at least one processor to alternatingly permit passage of individual vehicles of the at least one vehicle from each side of the convergence through the convergence. In some aspects, the memory comprises instructions that, when executed by the at least one processor, cause the at least one processor to alternatingly permit passage of platoons of vehicles of the at least one vehicle from each side of the convergence through the convergence.

### Exemplary Switch

As described herein, the drive units 70 can comprise a switch that is configured to selectively limit outward travel of one of the first and second side wheel assemblies relative to the main body along the transverse axis. FIG. 17 shows a schematic top-down perspective of an exemplary drive unit 70. The first and second side wheel assemblies can comprise side frames 84 that support the wheels. The side frames 84 can be movable along a linear bearing rail 212.

The drive unit 70 can comprise a servo 202 configured to rotate a bell-crank 204. The bell-crank 204 can be attached via a compression spring 206 to an escapement lever 208. The escapement lever 208 can be a double-pawled swivel lever. Actuation of the servo 202 can rotate the bell-crank (e.g., 90 degrees clockwise, as shown) in order to impart a clockwise torque on the escapement lever 208, when it is desired that the right-hand pawl restrain the right-hand side frame to its short limit of extension. As shown, the escapement lever 208 restrains the left-hand side frame to its short limit of extension, and this drive unit follows the left-hand path out of the next track bifurcation it encounters. The drive unit 70 can comprise three linear bearing blocks. Bearing blocks 210 can be mounted on a common transverse matching linear bearing rail 212, so as to allow side frames 84 freedom of movement to slide inboard and outboard, up to their mechanical limit stops, including the short limit set to either left or right by the servo 202 via the respective pawl of the escapement lever. A third linear bearing block 214 can be held in its forward most position by a tension spring 220. It slides longitudinally on its own linear bearing rail 216 held at its aft pivot point shown, so that it pushes link arms 222 that, in turn push slide blocks 210 outboard. When one side encounters its short limit (via the escapement lever 208), the other side is still pushed outboard to the track side-rail (or long limit). In this manner, the side frames are always sprung outboard, and always with a differential limit of extension. This disclosed assembly provides relatively high outward force, while requiring a relatively low force to effect switching between limits.

### Particular Exemplary Embodiments

Referring to FIG. 1, a double-flanged wheel rolls along the edge-rail such that its groove between the flanges is resting on the top of the edge-rail. Exemplary dimensions of the wheel profile are the 3/16″ wide by 3/16″ deep groove, with 3/16″ flange on each side. The edge rail can be ⅛″ wide and just over 5/16″ tall (approximately 5/16″ tall), such that the top of the edge rail is in contact with the bottom of the wheel groove. There is an upper and a lower double-flanged wheel on each drive-unit. The lower double-flanged wheel is strongly sprung (to support half the weight of the vehicle, whether fully loaded or unloaded), and the top wheel is lightly sprung upward, so as to engage the top edge-rail in the same manner as the lower wheel engages the lower edge-rail, with the exception of begin upside down. In this manner, the main frame of each traction unit is held aligned from top to bottom from roll. (Roll should be understood as pivotal movement relative to an axis perpendicular to the direction of vehicular travel along the edge-rails.) In addition to these upper and lower flanges wheels, each drive unit main frame has a pair of side frames on which are mounted drive motors, drive belt, drive pulley, idler pulley, and two vertical axles on each of which is a driven pulley fastened to the axle, and a drive/idler side wheel mounted to the axle on a one-way needle-bearing clutch. These side wheels are symmetrically mounted 2½″ forward and 2½″ aft of the top and bottom double-flanges wheel centerline. Each side frame is outboard sprung to hold both of its wheels against the sidewall of the track at centerline (equidistant from top to bottom of track). Thus, each drive unit has six points of contact with the track, at the six vertices of an octahedron. The left and right-side frames have inboard and outboard limits of travel so as to accommodate irregularities in track width up to approximately plus or minus ¼″ on each sidewall, and also a further extension available only to one side frame (or the other) at a time, of another ¾″. This mechanically set differential side extension capability functions together with the track geometry illustrated here so as to direct the drive unit out on the left or right track as set by the onboard switch as described.

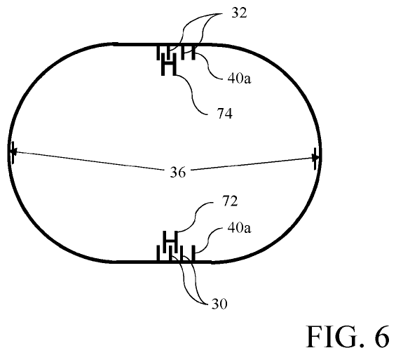

Referring to FIG. 1 and FIG. 2, a segment of the track system 20 is shown for an ordinary straight (or gently curved) track section. The side-wheels can be spring loaded through the side-frames against the left and right sidewalls 36 (optionally at a midline, about halfway up). FIGS. 1 and 3 illustrate the sidewalls diverging in a gentle outward V-shape as the vehicle proceeds down the track, so as to spread far enough that the two wheels on the side-frame whose outboard travel is limited lose contact with the side wall, just as the edge-rail (lower/upper track 30, 32) enters between the opposed side rails 40a. In this position, the two wheels on the side-frame whose outboard travel is at its long-limit maintain contact. This results in a net horizontal sideways force exerted in the upper and lower flanged wheels. The opposed side rails 40a,b can continue a gentle outward V as the vehicle proceeds (e.g., from an inside distance between the rails of ⅝″ to 1″) along length (e.g., about 48 inches). Along this same length of the divergence, the track sidewalls 36 can spread outboard in parallel with side-rail elements 40a,b. As the vehicle travels along this section of track, the single-sided spring-loaded contact along only one sidewall (left or right), results in the upper and lower double-flanged wheels 74, 72 being held against the inboard side of one side rail 40a and one side rail 40b, respectively. In this manner, as each vehicle drive-unit reaches the track at cross-section of FIG. 5, its upper and lower double-flanged wheel grooves engage either edge-rail 40a, 40b, respectively. Past this point, sidewall sections 36 gradually converge back inboard, so that sidewheel contact is again made by the sidewheels whose side-frame is still on its short-limit setting. This is in preparation for the edge-rails proceeding into a gradually divergent layout (e.g., 65-foot radius of curvature) so that the long-limit side wheels do not lose contact with their side wall before the short-limit side wheels regain contact with their wall. As the track rails and outboard side walls diverge, now the inboard side wheels (that are still on long-limit) can lose contact. The cross-section in FIG. 6 shows this oval. At the far right-hand side of FIG. 1, where the inboard clearance has grown far enough, a separation sidewall gradually funnels each side track into its own individual track, as shown in cross-section in FIG. 8. This gradual funneling engages the extended side wheels, restoring contact and traction all around. The side limit selection mechanism can now be set (if desired) to engage the opposite path at the next track bifurcation.

Both the front, and rear, drive units can be set to take the same fork (left or right). Simple interlock logic can enforce this, providing the input to the onboard control/navigation CPU.

This simple and effective onboard switch design provides advantages over conventional rail switches that require the track itself to move. The onboard switch allows all weight to be supported by metal wheel on metal rail, which minimizes coefficient of rolling resistance, and allows an energized circuit from bottom rail to top rail to provide power to the vehicles inside the track. The side wheels are traction (such as rubber, urethane, or other material to be determined), and spring loaded against the side walls at the minimum necessary to support rates of acceleration/deceleration, and strong enough to provide side motion adequate for reliable divergence at design speed. Side wheel outboard spring action is cammed to push harder outboard as side frame extends past short-limit to long-limit, as this supports the side push at divergence. Further, the side load can be varied with vehicle motor throttle, to provide variable traction as needed. The expense of variable side loading compared to the value of its installation can determine whether it is included. For example, in some aspects, variable side loading can be omitted from embodiments having an initial capillary gauge of approximately 8″ diameter enclosed track.

### Exemplary Vehicle and Track

Referring to FIGS. 1 and 2, in some aspects, the disclosed system is an integrated track/vehicle system for transport of single standard containers from point A to B, across a network. This track is enclosed, like an elevator shaft, but can be arranged horizontally and can have bifurcations and merges. One or more vehicles are supported by a lower rail, bottom dead center, and kept from tipping by a top rail, top dead center. Top and bottom rails are energized to less than 50 volts DC (VDC) (nominal 28 vdc). Vehicles are double articulated, with a front traction unit (like the tractor of a class 8 truck), and a rear traction unit. At least one traction unit (optionally, both traction units) can be motorized. Each traction is articulated to the center main frame (container carrier) via a single king-pin allowing freedom to yaw, but not pitch or roll. The top and bottom wheel of each traction unit is double flanged, so as to have a central groove into which the rail fits. The top and bottom wheels are steel (or other suitable metal) and serve also as power pickups, though direct rail wipers may also be used for power pickup. The top and bottom wheels are exactly above and below the connection kingpin to the main frame, such that the yaw action at the articulation point steers these wheels. Each traction unit has also four side-wheels, two left and two right, whose axles are vertical so that these wheels roll horizontally along the enclosed track sidewall at a point halfway between top and bottom, as well as on each side one being forward of the kingpin and the other aft of the kingpin by an equal amount, such that in total each traction unit has six wheels which are its only points of contact with the track. These points of contact roughly correlate to the six vertices of an equilateral octahedron. The main container frame is fully supported at the kingpin connection to the front and rear drive units.

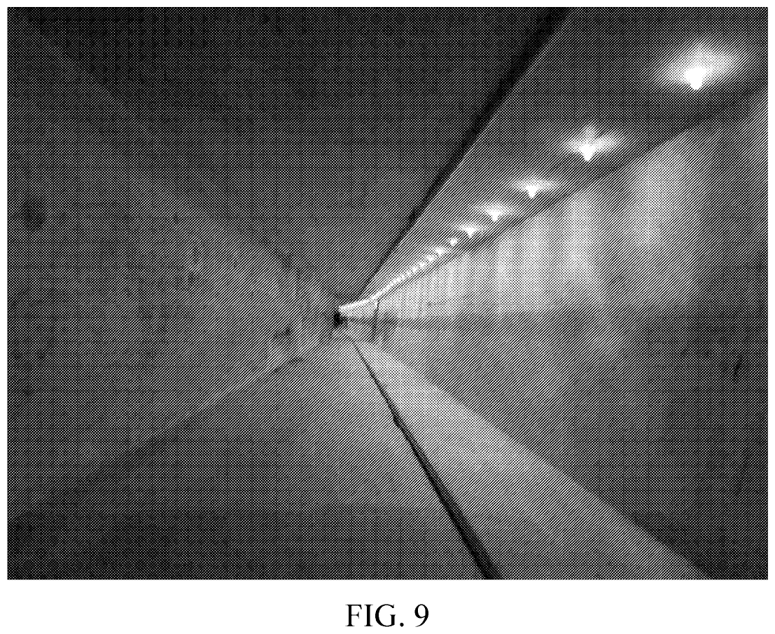

FIG. 9 illustrates a view looking down at a length of track just exiting a minimum radius (e.g., 42-inch radius of curvature) turn section. The top and bottom edge rails shown are 3¾ inches from the right hand wall, and a slight charcoal grey mark on the sidewall shows where the sidewheels have been making contact. (In this curvature exit track, the left side wheels do not make contact until the left wall closes from its present 7¾ inches distance from the rail, to within 4 inches of the rail, (about halfway down this view).

The bottom wheels of each traction unit are stiffly sprung, so as to yield no more than about ⅛ inch, and can be snubbed (motion limited by stops, such as rubber stops) not to squat more than 3/16 inch. The top wheel of each traction unit is soft sprung upward against the top rail, with a total throw of about ⅝ inch, to accommodate inserting and removing the vehicle from the track sideways (transversely to the direction of motion of along the track. The side wheels of each traction unit are mounted on left and right extension frames that hold them parallel to each other, and the traction unit frame. They each have only one degree of freedom, each able to slide independently and horizontally outboard from the traction unit frame. Each is sprung outboard, so as to apply force of the sidewheels (which are motor driven, and rubber treaded for grip) to the sidewall of the track.

### Switching

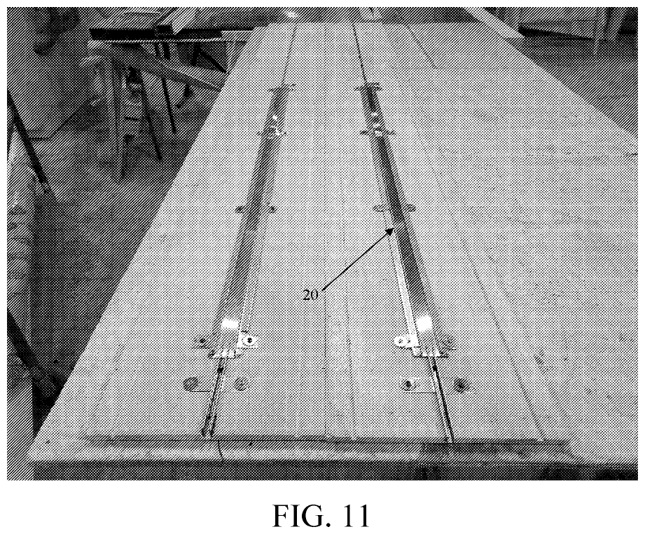

Referring to FIG. 11, the track components include sections that bifurcate from one path into two. The bifurcation includes a fork (optionally, an equilateral fork, in which the left and right exits each diverge from centerline, as opposed to the track proceeding straight, with a branch exiting either to left or to right). In some aspects, at the bifurcation, nothing of the track is a moving part (such as in typical railroad track). The path selection action can provided by a mechanism onboard each traction unit. The mechanism for selecting the path at the bifurcation is referred to herein as an “onboard switch.”

At the beginning of the fork, the track sidewalls begin a gentle outward V shape, each moving from 3¾″ to 4½″ from the center rails, along about 4 feet of running length. With this extra side clearance, only the side wheels not restrained from full outboard extension will maintain contact with the track, resulting in a differential sideways force on the vehicle. Next, the single over and under rails end into the centerline of over and under flat plate rails having lefthand and righthand flanges such that the double flanged wheels of the traction units proceed to roll on their left and right flanges onto the flat rail between the left and right rail flanges, and off the center rail in their center groove between the wheel flanges. (Exemplary dimensions are 3/16″ left and right wheel flanges, with a 3/16″ width and depth wheel groove in between, on a 2-inch diameter wheel.) Now proceeding along the next 4 feet, the flat rail side flanges spread in a gentle V-shape by about 3/16″, from an initial distance between each other of ⅝ inch, to final inside distance of 1 inch. Also, along this length, the track sidewall continues a gentle V spread, such that the restrained side frame wheels cannot contact their side wall. This causes the vehicle wheels to be pushed hard against either the left flat rail flange or the right, as determined by the onboard switch selection. At the end of this section, two upper and lower edge rails arise at the end of the side flanges flat rail, such that each is aligned for the double flanged wheel along the left or right flat rail side flange to proceed directly into the center groove of the double flanged wheel. At this point, each traction unit is trapped to the left or right top and bottom rails. Along the next 4 feet of track, the sidewalls are brought inboard in a gentle V-shape, to about 3¾″ from the nearest of the (now) two upper and lower rails (which are still 3/16″ apart). At this point, both sets of side-frame wheels are in contact with the sidewalls, restoring traction on either side. This is necessary, because in order to complete the fork, now the center rails and sidewall begin a gentle outboard curvature away from each other, removing the push-off side-frame wheels from their previous necessary push-off contact. An exemplary radius of curvature of this section is 65 feet, and once the track is separated such that its cross section is about 22 inches wide, and center wall begins and spreads in a gentle V, (which closes in toward the left and right rails of each diverging path until 3¾″ away from the rail, and so as to complete the bifurcation from one track into two.

This onboard switch, already unlike any other, has another novel and specific mechanism built into the lefthand pair and righthand pair of driven wheels: their drive train is lead wheel drive. Each side-frame has its own drive motor, driving a pulley for belt drive to both of its side wheels, and each sidewheel is connected to its belt pulley driven axle through a one-way needle roller overrun clutch, such that forward spin of the motor drives the forward wheel only, and reverse spin of the motor drives the rear wheel only. This lead wheel drive configuration keeps the rear wheel from applying traction in the direction of travel, preventing a sort of horizontal wheelie, which would twist the entire articulated traction unit frame on the kingpin and result in a braking action of the double flanges wheel twisting out of parallel with the edge rail it is riding on. No other vehicle of any type is equipped with lead-wheel drive, and for this scheme of onboard switch operation, lead wheel drive is the simplest and most reliable configuration (avoiding any sort of wheelie-bar, as seen behind drag racing cars)

The exemplary track fork just described runs a total length of 24 feet. The exemplary track fork is assembled of plywood and stainless steel in 8-foot sections: the selector, the gauntlet, and the spreader. FIG. 11 shows the top and bottom plates of the selector. In the exemplary embodiment shown in FIG. 11, the sidewall fitting grooves can be seen.

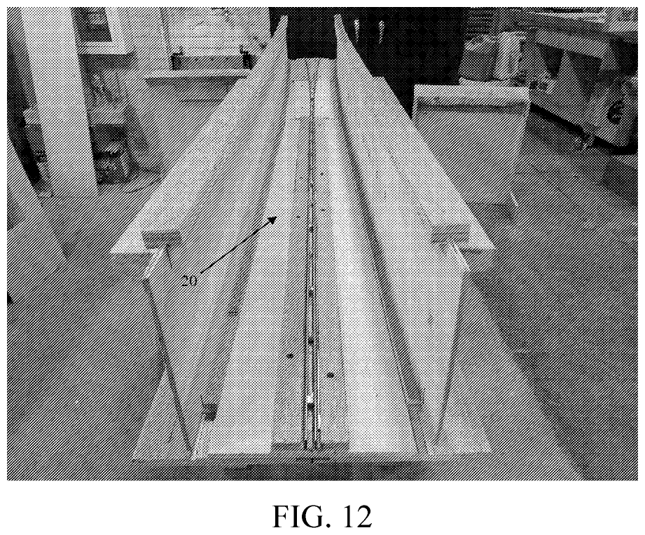

FIG. 12 illustrates the gauntlet. The gauntlet includes different sidewall construction of engineered I-beams employed for the sidewalls. Only the lower (or upper, as the track has over-under symmetry) rails are shown in FIG. 12.

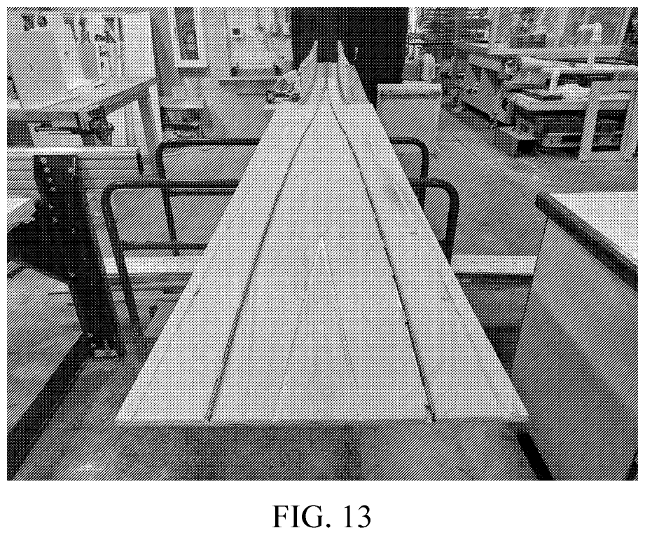

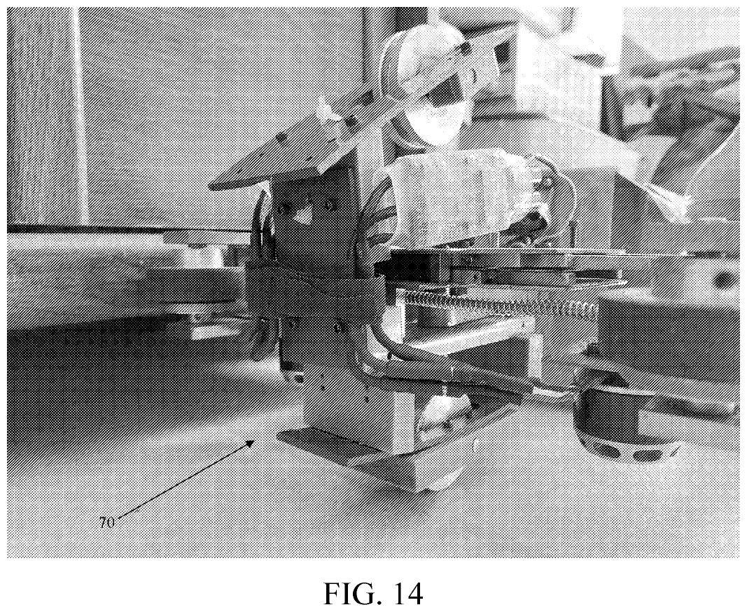

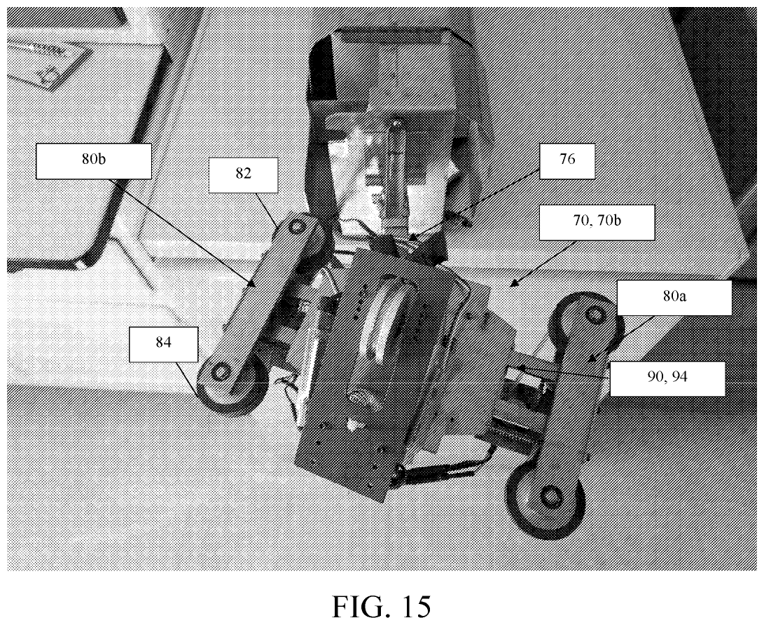

FIG. 13 shows the spreader. The illustrated spreader has grooves for sidewall mount, and is made so as to discharge two side by side tracks parallel to each other and to the original inbound single track (not shown) 8 feet upstream of the far end (of the gauntlet attached to the far end of the spreader plate) shown here.

The onboard switch can implement side drive wheel frames each having an outboard limit of throw and sharing a mechanism that restrains outboard throw on one side-frame or the other. A spring-loaded lever behaves as a two-sided ratchet-pawl (like a double-headed axe). It is spring loaded to rest far left or far right, but not in between, and is to be thrown by remote servo, solenoid, or other suitable device. There are two spring loaded pawls, both on a common pivoting mount, with the remote servo or solenoid actuating the pivot action to let one pawl, or the other, be spring up against a detent catch on the slide out action of just one side frame. When the servo or solenoid is actuated to its other position, the engaged spring-loaded pawl is retracted as the opposite spring-loaded pawl is engaged against its detent catch in the slide out action of its side frame. Front and rear traction units each have their own two-sided ratchet pawl, and each is thrown to the same signal. Misalignment of the front and rear traction units directs the lead traction unit down one path and the trailing traction unit down the other. Accordingly, such misalignment can be sensed, and, in response, the vehicle can be halted. In further aspects, the vehicle can include a mechanical interlock between forward and aft traction units as well as logical interlock through positional feedback sensors, like simple physical limit switches.

### Navigation

Each vehicle can include an electronic navigation system. In some aspects, the electronic navigation system can use markers installed in the track system to determine the position of the vehicle. Track system markers can use off-the-shelf technology, such as bar code, QR code, RFID tag, etc., to provide latitude, longitude, elevation, and track segment data to vehicles as they transit and read these location tags in passing. Accordingly, the vehicle can include a marker reader. Onboard each vehicle can be network map data, so that path from origin to destination can be calculated (e.g., using Dykstra's algorithm, or other) and recalculated as necessary in case of enforced detour. Each vehicle can possess a vehicle ID marker of chosen off-the-shelf technology, for track traffic monitoring and subsequent traffic flow advisement. Additionally, specific information messages can be passable between track and vehicles, such as vehicle disabled message, route unavailable message (e.g. “all traffic take left at next fork”, etc.). A merge algorithm, further disclosed herein, can enable each vehicle to anticipate that each merge will be on a time-partitioned cycle to accept traffic from left, neither, right, neither, repeat cycle. Default time partition can be equal left and right traffic acceptance, with equal (and shorter) buffer time intervals to accept traffic from neither left nor right. All vehicles can adjust speed so as to arrive as close to beginning of their permitted time interval as traffic allows, without following too closely (or contacting) traffic in front of them, resulting in platoons of vehicles moving through merges without interfering with traffic from other lane. Information passing between vehicles and track traffic advisement system can result in calculated reply information from traffic advisement to vehicles to adjust merge time partition to asymmetrical intervals to account for higher traffic from major feed lane vs. minor feed lane, as well as all traffic detour information in case of accidental blockage, also, traffic balancing to maximize total overall traffic, and finally, priority routing for emergency traffic.

### Additional Features

Another element of integrated system design is vehicle control algorithms, which at a high level involve synchronized approach to any section of track merging into another, such that there is a virtual traffic signal, known onboard each vehicle, that if approaching from the left merging branch, to arrive in the zone of merge during an interval of time corresponding the left side of a clock sweep (not necessarily of a minute, but some periodic length of seconds), with vehicles arriving from the right leg into a merge arriving during the right side of that same clock sweep. Both incoming lanes can avoid merging between the left and right clock sweeps. Testing and tuning (once multiple vehicles are available for run through a significant network) can determine if vehicles are platooned and the platoons thus zipper-merged, or if individual vehicles are alternatingly zipper merged. Additionally, network-to-vehicle communications can signal adjustments to approach times to deal with uneven incoming flows, such as to allow ⅔ clock sweep approach from heavy traffic side, ⅙ clock sweep from light traffic side, and remaining 2 segments of 1/12th clock sweep as buffer. This algorithm can minimize propulsion energy while maximizing throughput of the system.

The energized rail system can greatly reduce reliance on battery. Many other last-mile delivery modes, such as drones, sidewalk bots, self-driving electric road vehicles, cycle 100% of their energy through their traction battery. In some aspects, the exemplary system does not. Each vehicle can carry an onboard battery of roughly 50 Watt-hour capacity, whose nominal voltage (in the current incarnation) is 13 vdc. The track nominal voltage in this exemplary embodiment is 28 vdc. The vehicle can comprise pickup brushes on its upper and lower double-flanged idler wheels for receiving current from the rails. Onboard each vehicle is also an electric double-layer capacitor (aka ELDC, ultracapacitor, or supercapacitor), of about 29 to 37.5 Farads, and 32.4 to 36 volt rating. From the rail power pickups and the onboard battery leads, power is auctioneered (e.g., with two power supplies connected in parallel and operating as one power supply) through low forward impedance diodes (such as Schottky diodes) to the capacitor, which is also the motor power bus. In this way, rail power drives the vehicle directly, also tends to charge the capacitor to full voltage, and battery only supplies in case of capacitor voltage falling below about 13 volts DC. The capacitor collects and discharges about 2 Watt-hours of energy from 28 to 13 volts DC, which is enough to power the rail vehicle about a mile or two on level track. This utilization of onboard ELDC greatly minimized the necessary minimum distance of connecting track rail power feeds, by a factor of around 50 to 100. Additionally, the lower rail is powered, while the upper rail is ground. This makes two advantages of having a more robust lower rail than upper rail: lower rail bears weight and carries power, upper rail only participates in guidance and return to ground of power circuit, so can be smaller cross-section (cheaper) because more frequent ground taps are inexpensive (in comparison to power feeds). In further aspects, the rails 37 can be electrically coupled with the lower rail 30. This can maximize the current carrying capacity of the energized rail. This can further minimize the cost of power supplies along the track by allowing the necessary minimum distance between them to be maximized.

The enclosed track system can be kept at a positive pressure (e.g., about 1 or 2 psig dry air pressure). The positive pressure can allow air leakage out in event of a breach, preventing or minimizing water (or moisture) intrusion, and also providing driving head for water removal through simple float valves on drain-vents to the surface (or smaller diameter co-located water removal vacuum line).

Enclosed track lines can typically be co-located in doubles (e.g., one per direction) but also in cases triples (spare, or alternate direction extra line such as on many bridges) and singles (e.g., for a service loop for a series of 2 to 40 (or more) stations such as suburban homes, much like early ‘party-line’ phones). Co-located lines can have periodic adits (vents) that cross-tie ventilation between the two, so as to limit wind resistance in times of low traffic. (In high-traffic times, effective total wind resistance is minimized through the sharing of the load along a long series of vehicles moving in the same direction.)

The disclosed system takes advantage of the low rolling resistance of metal-on-metal for support of the load, and its conductivity for cutting battery expense. The disclosed system uses side traction so as to spring load normal force only as much as necessary for applied traction. Enclosed track is not only impervious to weather, but completely dry, for best traction. Additional aspects of the drive unit design beyond the exemplary embodiment disclosed herein are contemplated, including variable side wheel traction force couple to motor throttle demand. The variable side wheel traction can have a similar effect to that of anti-lock brakes, but is not as complex to implement, as the normal traction force necessary is always directly proportional to the motor load, regardless of acceleration, deceleration, or climbing. Also, traction unit mechanical design can include a form of extension to vertical support such that the vehicles can exit the enclosed track system and operate on their side-drive wheels (now supporting them) for limited range away from the track. Operation on the side-drive wheels can be most important for embodiments using greater gauge. In certain aspects, track diameter can be optimized at about 8 inches inside diameter, but larger gauge scale-up of the same technology to 19-inch (a gauge able to carry a bundle of 3 of the 8-inch lines), and subsequent trunk lines of about 44 inch (or such gauge as to carry a bundle of 3 of the 19 inch lines). At these larger scales, payload deliveries of cargos not able to be broken down for the smaller lines can be capable of reaching much broader areas by departing the main line and doing final mile(s) on battery alone.

Finally, the larger gauge can be used to provide personal transportation, and in one aspect, exiting the main line (protected from the weather and topping up the capacitor and batteries) across the final miles to destination, such as when a driver is leaving the freeway onto the city streets.

Accordingly, as should be understood, the intended implementations of this technology extend beyond embodiments disclosed herein. Accordingly, some aspects of the present disclosure can be used for a captive and capillary last-mile delivery (and first-mile reverse logistic) containerized parcel system. Additional aspects of the present disclosure can be used for transportation of any size (e.g., personal transportation) and across any distance.

The track power feeds can have not only grid supply to dc power supplies, but also low-cost, high-capacity stationary lead-acid storage batteries, so as to make this a utility that remains in operation hours, days, or even weeks into an electrical distribution power outage.

### Computing Device

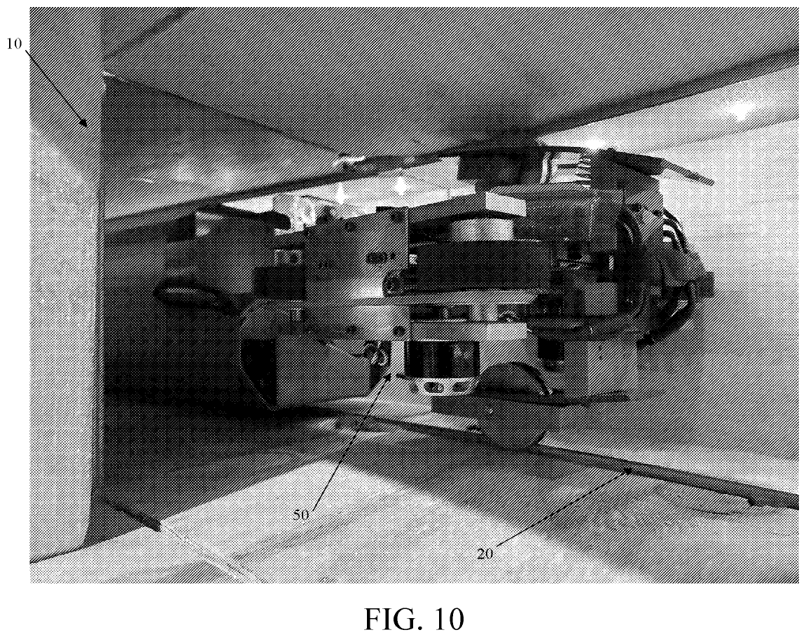

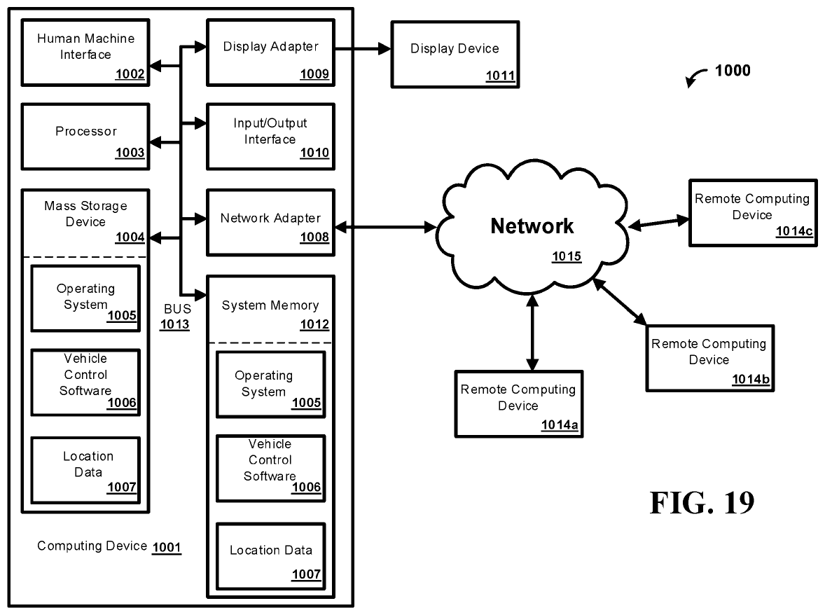

FIG. 19 shows an exemplary computing system 1000 including an exemplary configuration of a computing device 1001 that can be used with the system 10 (FIG. 10). In exemplary aspects, the computing device 1001 can be onboard the vehicle. In further aspects, a computing device (configured in accordance with computing device 1001) in communication with each vehicle can coordinate movement of the vehicles. In still further aspects, the computing devices of respective vehicles can communicate with each other to coordinate movement of the vehicles.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as, but not limited to read only memory (ROM).

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and vehicle control software 1006 may be stored on the mass storage device 1004. One or more of the operating system 1005 and/or vehicle control software 1006 (or some combination thereof) may comprise program modules and the vehicle control software 1006. Vehicle location data 1007 (e.g., position data) may also be stored on the mass storage device 1004. The location data 1007 may be stored in any of one or more databases known in the art. The databases may be centralized or distributed across multiple locations within the network 1015.

In some aspects, the computing device 1001 (server) may be a cloud-based or web-based server without departing from a broader scope of the present disclosure. In some aspects, the remote computing device 1014 may include an implementation of a client instance of the computing device 1001. As such, a user may interact with the computing device 1001 through the remote computing device 1014, e.g., the client instance implemented therein. In some aspects, the remote computing device 1014 may include processors, memory, display interfaces/devices, other output devices, sensors, features of the measuring device, etc., without departing from a broader scope of the present disclosure.

In some aspects, a user may enter commands and information into the computing device 1001 using an input device. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. In some aspects, any appropriate output from the computing device 1001 may be transmitted to the second computing device 30 and/or the remote computing device 1014 for presentation to a user via the client instance of the computing device 1001. Such output may be any form of visual representation, including, but not limited to, textual, graphical, animation, audio, tactile, and the like. The display device 1011 and computing device 1001 may be part of one device, or separate devices.

The computing device 1001 may operate in a networked environment using logical connections to one or more remote computing devices 1014a,b,c. The other remote computing devices 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, or other common network node, and so on. Logical connections between the computing device 1001 and the remote computing devices may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices can optionally have some or all of the components disclosed as being part of computing device 1001. In various further aspects, it is contemplated that some or all aspects of data processing described herein can be performed via cloud computing on one or more servers or other remote computing devices 1014. Accordingly, at least a portion of the system 1000 can be configured with internet connectivity.

### Method of Use

A method of using the system can comprise selectively limiting outward travel of the first side wheel assembly of a first vehicle of the at least one vehicle relative to the main body along the transverse axis. In aspects in which the track comprises a bifurcation 38 as disclosed herein, the method can further comprise advancing the first vehicle across the bifurcation. Advancing the first vehicle across the bifurcation can cause the vehicle to engage a receiving end portion of the pair of receiving end portions opposite the first side wheel assembly.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A system comprising:
a track system extending along an axis of travel, the track system comprising:
   a lower track;
   an upper track positioned vertically above the lower track; and
   opposed sidewalls that are spaced from each of the lower track and the upper track along a transverse axis; and
at least one vehicle movable along the track system, each vehicle of the at least one vehicle comprising:
   a main body defining a payload area; and
   at least one drive unit coupled to the main body, each drive unit of the at least one drive unit comprising:
      a lower wheel configured to engage the lower track;
      an upper wheel configured to engage the upper track; and
      first and second side wheel assemblies positioned on opposite sides of the drive unit, wherein the first and second side wheel assemblies are configured to independently and respectively engage the opposed sidewalls of the track system.

Aspect 2: The system of aspect 1, wherein the track system comprises a bifurcation comprising:
a first pair of opposed side rails spaced along the transverse axis and extending along the axis of travel of the track system, wherein the first pair of opposed side rails are positioned at a height to contact the upper wheel of the at least one vehicle, wherein the first pair of opposed side rails define a receiving space therebetween,
wherein the upper track comprises, within the receiving space:
   a releasing end portion that is configured to disengage from the upper wheel when the upper wheel travels beyond the releasing end portion along the axis of travel; and
   a pair of receiving end portions spaced from the releasing end portion along the axis of travel, wherein each receiving end portion of the pair of receiving end portions is configured to receive the upper wheel when the upper wheel reaches the end portion of the pair of receiving end portions, wherein the pair of receiving end portions are positioned relative to the first pair of opposed side rails so that when the upper wheel is in contact with, and traveling along, one of the opposed side rails, the upper wheel is aligned for engagement with the respective proximate receiving end portions.

Aspect 3: The system of aspect 2, wherein the bifurcation of the track system further comprises:
a second pair of opposed side rails spaced along the transverse axis and extending along the axis of travel of the track system, wherein the second pair of opposed side rails are positioned at a height to contact the lower wheel of the at least one vehicle, wherein the second pair of opposed side rails define a receiving space therebetween,
wherein the lower track comprises, within the receiving space:
   a releasing end portion that is configured to disengage from the lower wheel when the lower wheel travels beyond the releasing end portion along the axis of travel; and
   a pair of receiving end portions spaced from the releasing end portion along the axis of travel, wherein each receiving end portion of the pair of receiving end portions is configured to receive the lower wheel when the lower wheel reaches the end portion of the pair of receiving end portions, wherein the pair of receiving end portions are positioned relative to the second pair of opposed side rails so that when the lower wheel is in contact with, and traveling along, one of the opposed side rails, the lower wheel is aligned for engagement with the respective proximate receiving end portions.

Aspect 4: The system of any one of the preceding aspects, wherein the first and side wheel assemblies of the at least one drive unit of the at least one vehicle are biased outwardly from the main body along the transverse axis.

Aspect 5: The system of any one of the preceding aspects, wherein the at least one vehicle comprises at least one switch that is configured to selectively limit outward travel of one of the first and second side wheel assemblies relative to the main body along the transverse axis.

Aspect 6: The system of aspect 5, wherein the first and second side wheel assemblies each comprise a body that is movable along the transverse axis and at least one wheel mounted to the body,
wherein the at least one switch comprises:
a double-pawled swivel lever; and
an actuator that is configured to select a position of the double-pawled swivel lever,
wherein the double-pawled swivel lever is configured to selectively engage one of the body of either the first side wheel assembly or the second side wheel assembly based on the position selected by the actuator.

Aspect 7: The system of aspect 5, wherein the at least one switch comprises a pawl and ratchet, wherein the pawl is configured to engage the ratchet to inhibit outward travel of one of the first and second side wheel assemblies relative to the main body along the transverse axis.

Aspect 8: The system of any one of the preceding aspects, wherein the upper wheel and the lower wheel are each spring-biased away from the main body of the at least one vehicle.

Aspect 9: The system of any one of the preceding aspects, wherein each drive unit of the at least one drive unit of the at least one vehicle comprises at least one motor, wherein the first and second side wheel assemblies of the at least one vehicle each comprise at least one drive wheel that is operatively coupled to the at least one electric motor.

Aspect 10: The system of aspect 9, wherein the at least one vehicle comprises a battery in electrical communication with the at least one electric motor.

Aspect 11: The system of aspect 10, wherein the upper track and lower track have a voltage differential therebetween, wherein the at least one vehicle is configured to draw power from the voltage differential between the upper track and the lower track.

Aspect 12: The system of any one of the preceding aspects, wherein the at least one vehicle comprises circuitry comprising:
a capacitor; and
at least one diode,
wherein the circuitry is configured to auctioneer power in order to prioritize power usage from the voltage differential between the upper track and the lower track.

Aspect 13: The system of any one of the preceding aspects, wherein the at least one drive unit comprises a front drive unit coupled to the front of the main body of the at least one vehicle and a rear drive unit coupled to the rear of the main body of the at least one vehicle.

Aspect 14: The system of aspect 13, wherein the front and rear drive units are coupled to the body of the at least one vehicle via respective connections that permit articulation about respective pivotal axes that are perpendicular to the axis of travel.

Aspect 15: The system of aspect 14, wherein the respective connections each comprise a kingpin, wherein the respective connections between the front and rear drive units and the main body permit a minimum turn radius of less than 50 inches for a main body having a length between the kingpins of the respective connections of about 35 inches.

Aspect 16: The system of any one of the preceding aspects, wherein each of the first and second side wheel assemblies comprises a front wheel and a rear wheel.

Aspect 17: The system of aspect 16, wherein the front wheel is positioned outwardly along the transverse axis relative to the rear wheel.

Aspect 18: The system of any one of the preceding aspects, further comprising:
a computing device in communication with each vehicle of the at least one vehicle, wherein the computing device comprises:
at least one processor; and
a memory in communication with the at least one processor, wherein the memory comprises instructions that, when executed by the at least one processor, cause the at least one processor to:
control movement of each vehicle of the at least one vehicle.

Aspect 19: The system of aspect 18, wherein the track system comprises at least one track convergence, wherein the memory comprises instructions that, when executed by the at least one processor, cause the at least one processor to:
control movement of each vehicle of the at least one vehicle to prevent collisions at the convergence.

Aspect 20: The system of aspect 19, wherein the memory comprises instructions that, when executed by the at least one processor, cause the at least one processor to:
alternatingly permit passage of individual vehicles of the at least one vehicle from each side of the convergence through the convergence.

Aspect 21: The system of aspect 19, wherein the memory comprises instructions that, when executed by the at least one processor, cause the at least one processor to:
alternatingly permit passage of platoons of vehicles of the at least one vehicle from each side of the convergence through the convergence.

Aspect 22: A method of using the system of any one of the preceding aspects, the method comprising:
selectively limiting outward travel of the first side wheel assembly of a first vehicle of the at least one vehicle relative to the main body along the transverse axis.

Aspect 23: The method of aspect 22, wherein the track system comprises a bifurcation comprising:
a first pair of opposed side rails spaced along the transverse axis and extending along the axis of travel of the track system, wherein the first pair of opposed side rails are positioned at a height to contact the upper wheel of the at least one vehicle, wherein the first pair of opposed side rails define a receiving space therebetween,
wherein the upper track comprises, within the receiving space:
   a releasing end portion that is configured to disengage from the upper wheel when the upper wheel travels beyond the releasing end portion along the axis of travel; and
   a pair of receiving end portions spaced from the releasing end portion along the axis of travel, wherein each receiving end portion of the pair of receiving end portions is configured to receive the upper wheel when the upper wheel reaches the end portion of the pair of receiving end portions, wherein the pair of receiving end portions are positioned relative to the first pair of opposed side rails so that when the upper wheel is in contact with, and traveling along, one of the opposed side rails, the upper wheel is aligned for engagement with the respective proximate receiving end portions,
wherein the method further comprises:
   advancing the first vehicle across the bifurcation, wherein advancing the first vehicle across the bifurcation causes the vehicle to engage a receiving end portion of the pair of receiving end portions opposite the first side wheel assembly.

Although the foregoing invention has been described in some detail by way of illustration and example for purposes of clarity of understanding, certain changes and modifications may be practiced within the scope of the appended claims.

What is claimed is:

1. A system comprising:
a track system extending along an axis of travel, the track system comprising:
a lower track;
an upper track positioned vertically above the lower track; and
opposed sidewalls that are spaced from each of the lower track and the upper track along a transverse axis; and
at least one vehicle movable along the track system, each vehicle of the at least one vehicle comprising:
a main body defining a payload area; and
at least one drive unit coupled to the main body, each drive unit of the at least one drive unit comprising:
a lower wheel configured to engage the lower track;
an upper wheel configured to engage the upper track; and
first and second side wheel assemblies positioned on opposite sides of the drive unit, wherein the first and second side wheel assemblies are configured to independently and respectively engage the opposed sidewalls of the track system.

2. The system of claim 1, wherein the track system comprises a bifurcation comprising:
a first pair of opposed side rails spaced along the transverse axis and extending along the axis of travel of the track system, wherein the first pair of opposed side rails are positioned at a height to contact the upper wheel of the at least one vehicle, wherein the first pair of opposed side rails define a receiving space therebetween,
wherein the upper track comprises, within the receiving space:
a releasing end portion that is configured to disengage from the upper wheel when the upper wheel travels beyond the releasing end portion along the axis of travel; and
a pair of receiving end portions spaced from the releasing end portion along the axis of travel, wherein each receiving end portion of the pair of receiving end portions is configured to receive the upper wheel when the upper wheel reaches the end portion of the pair of receiving end portions, wherein the pair of receiving end portions are positioned relative to the first pair of opposed side rails so that when the upper wheel is in contact with, and traveling along, one of the opposed side rails, the upper wheel is aligned for engagement with the respective proximate receiving end portions.

3. The system of claim 2, wherein the bifurcation of the track system further comprises:
a second pair of opposed side rails spaced along the transverse axis and extending along the axis of travel of the track system, wherein the second pair of opposed side rails are positioned at a height to contact the lower wheel of the at least one vehicle, wherein the second pair of opposed side rails define a receiving space therebetween,
wherein the lower track comprises, within the receiving space:
a releasing end portion that is configured to disengage from the lower wheel when the lower wheel travels beyond the releasing end portion along the axis of travel; and
a pair of receiving end portions spaced from the releasing end portion along the axis of travel, wherein each receiving end portion of the pair of receiving end portions is configured to receive the lower wheel when the lower wheel reaches the end portion of the pair of receiving end portions, wherein the pair of receiving end portions are positioned relative to the second pair of opposed side rails so that when the lower wheel is in contact with, and traveling along, one of the opposed side rails, the lower wheel is aligned for engagement with the respective proximate receiving end portions.

4. The system of claim 1, wherein the first and side wheel assemblies of the at least one drive unit of the at least one vehicle are biased outwardly from the main body along the transverse axis.

5. The system of claim 1, wherein the at least one vehicle comprises at least one switch that is configured to selectively limit outward travel of one of the first and second side wheel assemblies relative to the main body along the transverse axis.

6. The system of claim 5, wherein the first and second side wheel assemblies each comprise a body that is movable along the transverse axis and at least one wheel mounted to the body,
wherein the at least one switch comprises:
a double-pawled swivel lever; and
an actuator that is configured to select a position of the double-pawled swivel lever,
wherein the double-pawled swivel lever is configured to selectively engage one of the body of either the first side wheel assembly or the second side wheel assembly based on the position selected by the actuator.

7. The system of aspect 5, wherein the at least one switch comprises a pawl and ratchet, wherein the pawl is configured to engage the ratchet to inhibit outward travel of one of the first and second side wheel assemblies relative to the main body along the transverse axis.

8. The system of claim 1, wherein the upper wheel and the lower wheel are each spring-biased away from the main body of the at least one vehicle.

9. The system of claim 1, wherein each drive unit of the at least one drive unit of the at least one vehicle comprises at least one motor, wherein the first and second side wheel assemblies of the at least one vehicle each comprise at least one drive wheel that is operatively coupled to the at least one electric motor.

10. The system of claim 9, wherein the at least one vehicle comprises a battery in electrical communication with the at least one electric motor.

11. The system of claim 10, wherein the upper track and lower track have a voltage differential therebetween, wherein the at least one vehicle is configured to draw power from the voltage differential between the upper track and the lower track.

12. The system of claim 1, wherein the at least one vehicle comprises circuitry comprising:
a capacitor; and
at least one diode,
wherein the circuitry is configured to auctioneer power in order to prioritize power usage from the voltage differential between the upper track and the lower track.

13. The system of claim 1, wherein the at least one drive unit comprises a front drive unit coupled to a front of the main body of the at least one vehicle and a rear drive unit coupled to a rear of the main body of the at least one vehicle.

14. The system of claim 13, wherein the front and rear drive units are coupled to the body of the at least one vehicle via respective connections that permit articulation about respective pivotal axes that are perpendicular to the axis of travel.

15. The system of claim 14, wherein the respective connections each comprise a kingpin, wherein the respective connections between the front and rear drive units and the main body permit a minimum turn radius of less than 50 inches for a main body having a length between the kingpins of the respective connections of about 35 inches.

16. The system of claim 1, wherein each of the first and second side wheel assemblies comprises a front wheel and a rear wheel.

17. The system of claim 16, wherein the front wheel is positioned outwardly along the transverse axis relative to the rear wheel.

18. The system of claim 1, further comprising:
a computing device in communication with each vehicle of the at least one vehicle, wherein the computing device comprises:
at least one processor; and
a memory in communication with the at least one processor, wherein the memory comprises instructions that, when executed by the at least one processor, cause the at least one processor to:
control movement of each vehicle of the at least one vehicle.

19. The system of claim 18, wherein the track system comprises at least one track convergence, wherein the memory comprises instructions that, when executed by the at least one processor, cause the at least one processor to:
control movement of each vehicle of the at least one vehicle to prevent collisions at the convergence.

20. The system of claim 19, wherein the memory comprises instructions that, when executed by the at least one processor, cause the at least one processor to:
alternatingly permit passage of individual vehicles of the at least one vehicle from each side of the convergence through the convergence.

21. The system of claim 19, wherein the memory comprises instructions that, when executed by the at least one processor, cause the at least one processor to:
alternatingly permit passage of platoons of vehicles of the at least one vehicle from each side of the convergence through the convergence.

22. A method of using the system of claim 1 the method comprising:
selectively limiting outward travel of the first side wheel assembly of a first vehicle of the at least one vehicle relative to the main body along the transverse axis.

23. The method of claim 22, wherein the track system comprises a bifurcation comprising:
a first pair of opposed side rails spaced along the transverse axis and extending along the axis of travel of the track system, wherein the first pair of opposed side rails are positioned at a height to contact the upper wheel of the at least one vehicle, wherein the first pair of opposed side rails define a receiving space therebetween,
wherein the upper track comprises, within the receiving space:
a releasing end portion that is configured to disengage from the upper wheel when the upper wheel travels beyond the releasing end portion along the axis of travel; and
a pair of receiving end portions spaced from the releasing end portion along the axis of travel, wherein each receiving end portion of the pair of receiving end portions is configured to receive the upper wheel when the upper wheel reaches the end portion of the pair of receiving end portions, wherein the pair of receiving end portions are positioned relative to the first pair of opposed side rails so that when the upper wheel is in contact with, and traveling along, one of the opposed side rails, the upper wheel is aligned for engagement with the respective proximate receiving end portions,
wherein the method further comprises:
advancing the first vehicle across the bifurcation, wherein advancing the first vehicle across the bifurcation causes the vehicle to engage a receiving end portion of the pair of receiving end portions opposite the first side wheel assembly.
